(19) United States
(12) Patent Application Publication
(10) Pub. No.: US 2018/0107473 A1
(43) Pub. Date: Apr. 19, 2018

(54) DETERMINING WHETHER TO INSTALL A VEHICLE SYSTEM UPDATE IN A VEHICLE

(71) Applicant: GM GLOBAL TECHNOLOGY OPERATIONS LLC, Detroit, MI (US)

(72) Inventors: Wahaj Ahmed, Bloomfield Hills, MI (US); Kenneth P. Orlando, Sterling Heights, MI (US); Alan D. Wist, Macomb, MI (US); Mahesh Balike, Farmington Hills, MI (US)

(21) Appl. No.: 15/292,764

(22) Filed: Oct. 13, 2016

(51) Int. Cl. G06F 9/445; H04L 29/08

(52) U.S. Cl. CPC G06F 8/665; G06F 8/61; H04L 67/34; H04L 67/12

(57) ABSTRACT

A software update system for a vehicle is disclosed, as well as a method of determining whether to install a software update at an electronic control unit (ECU) in the vehicle. The method includes the steps of: receiving at the ECU a first signal from a first vehicle system module (VSM) in the vehicle; receiving at the ECU a second signal from a second VSM in the vehicle, wherein the first and second signals each provide an indication that the vehicle is in a stationary state; based on the first and second signals, assessing at the ECU that the vehicle is in the stationary state, wherein the assessment is in accordance with a first predetermined confidence level; and in response to the assessment, authorizing at the ECU an installation of the software update on ECU memory.

### TECHNICAL FIELD

The present invention relates to installing vehicle system updates in a vehicle, and more particularly, to installing updates in vehicle system modules and/or electronic control units in the vehicle.

### BACKGROUND

Vehicle computer modules often utilize software (e.g., or firmware or the like) to carry out various vehicle functions. A vehicle manufacturer may install the software initially in a vehicle module; however, from time to time, the manufacturer may develop updates or new software which improves the performance or increases the capabilities of the module. These updates may be provided to the vehicle by wire at a vehicle service center or wirelessly via so-called ‘over-the-air’ (OTA) communications. When these updates are provided at the vehicle service center, they are typically installed by service technicians who are trained to render the vehicle stationary before installing the update. However, when the updates are received via the OTA method, a vehicle end user may participate in the installation process, and the vehicle user may not follow the same procedures. For example, the user may attempt to install the updates while the vehicle is moving—and if the vehicle is moving or being operated during the installation of the updates, the vehicle may not operate properly—e.g., since the targeted vehicle module could be de-activated or at least partially disabled temporarily during the installation process. Thus, installation, in at least some instances, may endanger the user as certain vehicle systems may be inoperative.

Thus, there is a general need to inhibit vehicle functionality during the installation process. And for example, there is a more specific need to determine at a vehicle computer whether the vehicle is stationary prior to permitting the installation of the update in a vehicle module. Furthermore, since the installation process may be performed by computer(s), there is a need to determine that the vehicle is stationary with a high level of confidence.

### SUMMARY

According to an embodiment of the invention, there is provided a method of determining whether to install a software update at an electronic control unit (ECU) in a vehicle. The method includes: receiving at the ECU a first signal from a first vehicle system module (VSM) in the vehicle; receiving at the ECU a second signal from a second VSM in the vehicle, wherein the first and second signals each provide an indication that the vehicle is in a stationary state; based on the first and second signals, assessing at the ECU that the vehicle is in the stationary state, wherein the assessment is in accordance with a first predetermined confidence level; and in response to the assessment, authorizing at the ECU an installation of the software update on ECU memory.

According to another embodiment of the invention, there is provided a software update system for a vehicle. The system includes: a vehicle system module (VSM) configured to determine a first assessment of whether the vehicle is in a stationary state using a first set of parameters; a gateway module configured to determine a second assessment of whether the vehicle is in the stationary state using a second set of parameters, wherein at least some of the parameters of the second set differ from the parameters of the first set; and a target electronic control unit (ECU) having a processor coupled to memory, wherein the memory stores a plurality of instructions executable by the processor, including: instructions to receive data associated with the first and second assessments from the VSM and the gateway module, respectively; instructions to assess whether the vehicle is in the stationary state in response to receiving the first assessment data and the second assessment data; and instructions to authorize an installation of a software update when the processor determines that the vehicle is in the stationary state.

According to another embodiment of the invention, there is provided a computer program product that includes a non-transitory computer readable medium for an electronic control unit (ECU) in a vehicle that includes computer program instructions that enable a processor of the ECU to install a software update in memory of the ECU when the vehicle is in a stationary state. The computer program instructions include: instructions to receive a first signal from a vehicle system module (VSM) in the vehicle, wherein the first signal is associated with an assessment by the VSM that the vehicle is in the stationary state; instructions to receive a second signal from a gateway module in the vehicle, wherein the second signal is associated with an assessment by the gateway module that the vehicle is in the stationary state; instructions to determine whether the vehicle is in the stationary state in response to receiving the first and second signals, wherein the determination is in accordance with a predetermined confidence level; instructions to authorize an installation of the software update when the processor determines that the vehicle is in the stationary state; based on the authorization, instructions to receive the software update from one of a plurality of VSMs in the vehicle; and based on receiving the instructional update, instructions to reflash the memory device with the software update.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram of an installation update system for a vehicle; and

FIG. 3 is a flow diagram of a method of determining whether to install an instructional update at an electronic control unit (ECU) in the vehicle.

### DETAILED DESCRIPTION OF THE ILLUSTRATED EMBODIMENT(S)

A software update system for a vehicle is described below which is adapted to control an installation of a vehicle system update in a vehicle system module (e.g., in an electronic control unit (ECU) thereof). The software system update may be adapted to update software, firmware, instructional code, or any other suitable instructions for a configurable or programmable electronic device. Prior to conducting the installation in the ECU, the software update system determines with a high level of confidence that the vehicle is in a stationary state. According to one example, before initiating the update of an ECU, the software update system determines whether the vehicle is moving and inhibits the update of the ECU until the vehicle is determined to be stationary. Further, the update system may account for one or more vehicle systems providing false readings or data to the software update system—e.g., due to a malfunction of a vehicle hardware, due to a programming bug in vehicle software, or due to malicious activity by vehicle hackers, just to name a few examples. The update system, as well as its implementation, will be discussed in greater detail below.

### Communications System

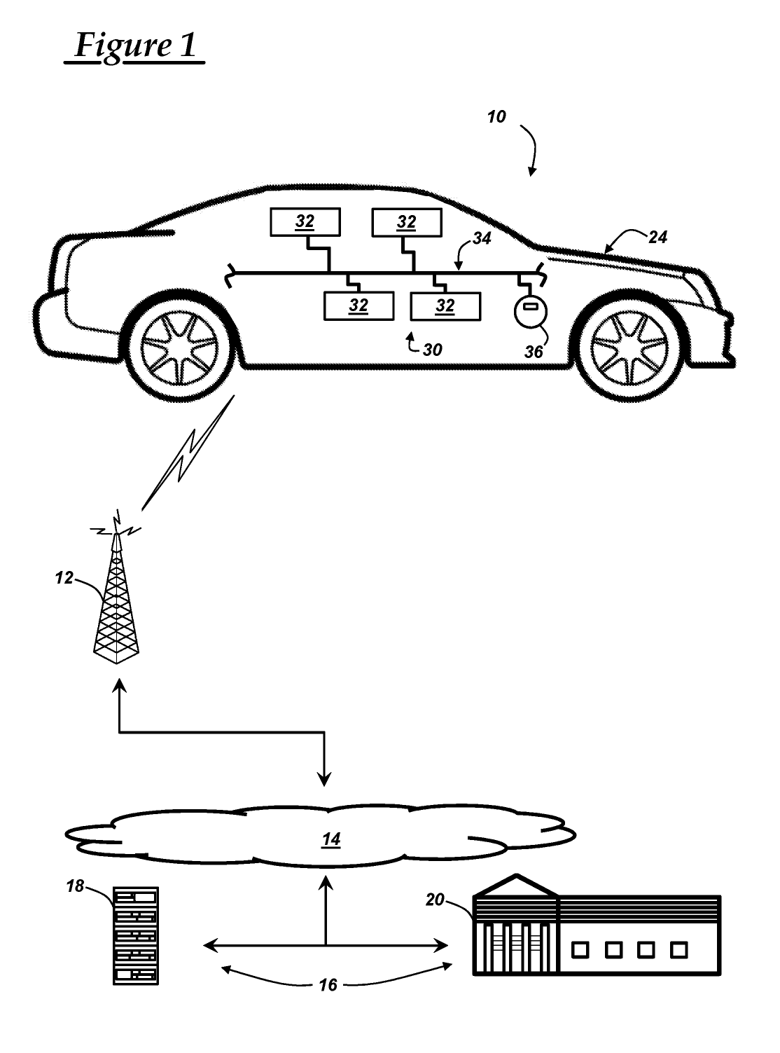

With reference to FIG. 1, there is shown an operating environment that comprises a mobile vehicle communications system 10 and that can be used to implement the method disclosed herein. Communications system 10 generally includes: one or more wireless carrier systems 12; a land communications network 14; a vehicle backend system 16 that includes at least one of a remote server 18 or a data service center 20; and a vehicle 24. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system 12 is preferably a cellular telephone system that includes a plurality of cell towers (only is one shown), one or more mobile switching centers (MSCs) (not shown), as well as any other networking components required to connect wireless carrier system 12 with land network 14. Each cell tower includes sending and receiving antennas and a base station, with the base stations from different cell towers being connected to the MSC either directly or via intermediary equipment such as a base station controller. Cellular system 12 can implement any suitable communications technology, including for example, analog technologies such as AMPS, or the newer digital technologies such as LTE, CDMA (e.g., CDMA2000), or GSM/GPRS. As will be appreciated by those skilled in the art, various cell tower/base station/MSC arrangements are possible and could be used with wireless system 12. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Land network 14 may be a conventional land-based telecommunications network that is connected to one or more landline telephones and connects wireless carrier system 12 to backend system 16. For example, land network 14 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof. Furthermore, data service center 20 need not be connected via land network 14, but could include wireless telephony equipment so that it can communicate directly with a wireless network, such as wireless carrier system 12.

Remote server 18 can be one of a number of computers accessible via a private or public network such as the Internet. Each such server 18 can be used for one or more purposes, such as a web server accessible via land network 14 and/or wireless carrier 12. Other such accessible servers 18 can be, for example: a service center computer where diagnostic information and other vehicle data can be uploaded from the vehicle 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 24 or data service center 20, or both. Remote server 18 can also be used for providing Internet connectivity such as DNS services or as a network address server that uses DHCP or other suitable protocol to assign an IP address to the vehicle 24.

Data service center 20 is designed to provide the vehicle 24 with a number of different system back-end functions and generally includes one or more switches, servers, databases, live advisors, as well as an automated voice response system (VRS), all of which are known in the art. These various data service center components are preferably coupled to one another via a wired or wireless local area network. Switch, which can be a private branch exchange (PBX) switch, routes incoming signals so that voice transmissions are usually sent to either the live adviser by regular phone or to the automated voice response system using VoIP. The live advisor phone can also use VoIP; VoIP and other data communication through the switch may be implemented via a modem connected between the switch and network. Data transmissions are passed via the modem to server and/or database. Database can store account information such as subscriber authentication information, vehicle identifiers, profile records, behavioral patterns, and other pertinent subscriber information. Data transmissions may also be conducted by wireless systems, such as 802.11x, GPRS, and the like. Although one embodiment has been described as it would be used in conjunction with a manned data service center 20 using a live advisor, it will be appreciated that the data service center can instead utilize VRS as an automated advisor or, a combination of VRS and a live advisor can be used.

As shown in FIG. 1, vehicle 24 is depicted as a passenger car, but it should be appreciated that any other vehicle including motorcycles, trucks, sports utility vehicles (SUVs), recreational vehicles (RVs), marine vessels, aircraft, etc., can also be used. Vehicle 24 may include a vehicle software update system 30 that includes one or more vehicle system modules (VSMs) 32, one or more network connections 34, a vehicle ignition system 36, and various other vehicle electronic modules, circuits, sensors, switches, etc. (which will be described more below).

In general, VSMs 32 can include any suitable hardware modules in the vehicle 24, each of which may be configured to perform one or more different vehicle functions or tasks. Non-limiting examples of VSMs 32 include an engine control module (ECM) that controls various aspects of engine operation such as fuel ignition and ignition timing and a powertrain control module (PCM) that regulates operation of one or more components of the vehicle powertrain. According to one embodiment, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. Other VSM implementations will be apparent to skilled artisans.

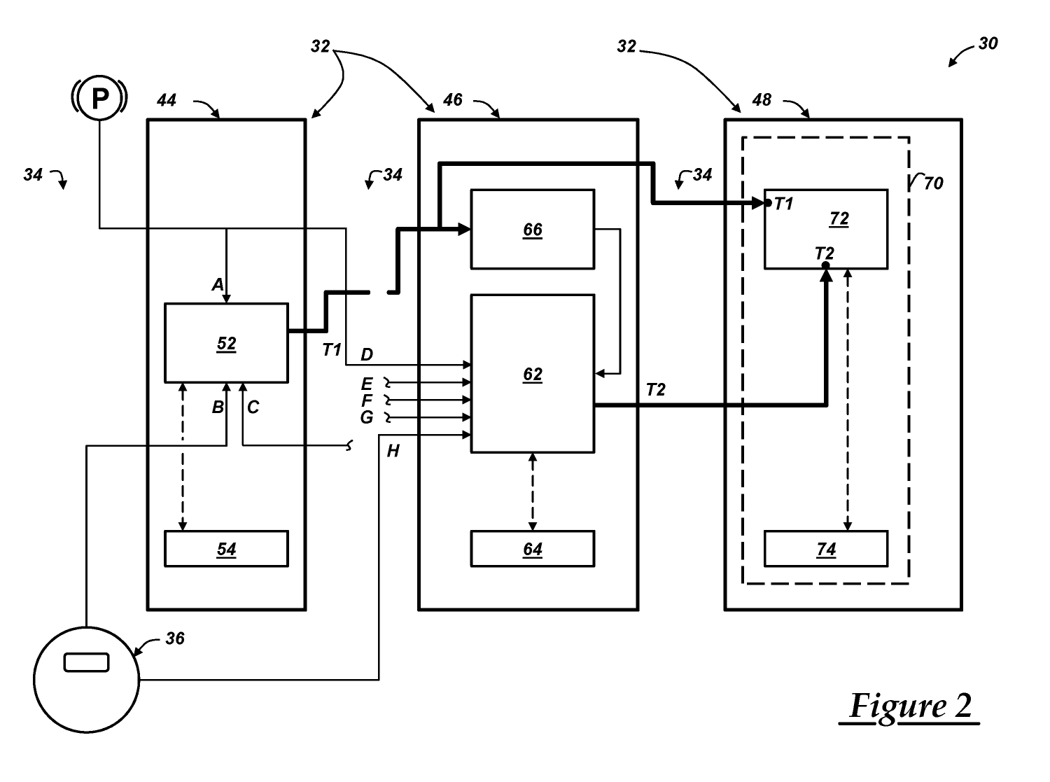

Turning to FIG. 2, one embodiment of the vehicle software update system 30 is shown that includes several VSMs 32 (namely, a body control module (BCM) 44, a gateway module 46, and a target VSM 48), as well as the vehicle ignition system 36. It will be appreciated that these VSMs 44-48 are merely examples; e.g., in the description that follows, other VSMs 32 could have been used instead of these modules to carry out the method described herein.

The illustrated BCM 44 includes a processor 52 coupled to memory 54. Processor 52 can be any type of device capable of processing and/or executing instructions, including microprocessors, microcontrollers, host processors, controllers, vehicle communication processors, and application specific integrated circuits (ASICs). It may be a dedicated processor (used only for module 44), or it can be shared with other vehicle systems. For example, in at least one embodiment, the processor 52 may perform or execute a number of instructions stored on memory 54, including one or more of the following: (1) receiving electrical inputs or parameters from various vehicle system modules, circuits, sensors, switches, etc. (e.g., which may be indicia that the vehicle is in a stationary state); (2) assessing or determining whether the vehicle 24 appears to be in the stationary state based on the received electrical parameters, wherein the assessment has a certain confidence level; and (3) in response to receiving the parameters and making an assessment that the vehicle 24 appears to be in the stationary state (wherein the assessment meets or exceeds a predetermined threshold confidence level), then providing a first trigger or other suitable signal as an output (e.g., see T1). Thus, the processor 52 may carry out at least a portion of the method described herein, as will be discussed in greater detail below.

In FIG. 2, processor 52 is shown receiving electrical parameters A, B, C—wherein parameter A is received from a mechanical parking brake sensor P on the vehicle 24, parameter B is received from the ignition system 36, and parameter C may be received from one more additional sources such as a vehicle seat sensor, a vehicle door position indicator (closed or ajar), a wireless proximity sensor in the vehicle cabin, a vehicle module that sends an immobilization signal (e.g., over a vehicle communication bus), or the like. It should be appreciated that these and other parameters may be received by the BCM processor 52 and may be used to determine whether the vehicle 24 is in non-stationary state or a stationary state.

The non-stationary state may include instances where the vehicle 24 is moving or the vehicle 24 is static or still but the transmission is in DRIVE, REVERSE, or is similarly capable of being operated by a vehicle user. A stationary state includes a condition wherein the vehicle 24 is not moving whether the engine is on or off and the vehicle is in PARK. In at least one embodiment, the vehicle mechanical (or so-called emergency) brake is actuated or applied as well. These are merely examples of a stationary state; of course, other implementations exist. As will be explained more below, various mechanical, electrical, and/or software controls may assist update system 30 in determining whether the vehicle 24 is in the stationary state—e.g., the update system 30 may use mechanical hardware or systems within the vehicle 24, electrical circuits or control systems within the vehicle, programming instructions within the vehicle 24, etc.

Memory 54 of BCM 44 may be used to store parameter data (e.g., A-C data) and other data associated with the operation of the BCM. Memory 54 includes any non-transitory computer usable or readable medium, which includes one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one implementation, the memory 54 includes non-volatile memory (e.g., ROM, EPROM, EEPROM, etc.). These of course are merely examples; other implementations are contemplated herein.

The gateway module 46 may be configured to provide a variety of communication services. For example, the module 46 may include one or more wireless chipsets (not shown) enabling the gateway module to communicate via cellular communication over the wireless carrier system 12 (e.g., LTE, CDMA, GSM, etc.), as well as via short range wireless communication (SRWC) with other local wireless devices, other vehicle devices, and the like. For example, SRWC includes but is not limited to technologies such as Bluetooth, BLE, Wi-Fi, Wi-Fi Direct, etc. In at least some embodiments, the gateway module 46 is located in a center stack or instrument panel of vehicle 24 and includes a user interface device (e.g., buttons, knobs, touch-screen, etc.) (not shown). For example, the module 46 may provide vehicle user(s) with entertainment and infotainment services via an internet connection, via AM/FM/Satellite radio, via one or more of a CD, DVD, or MP3 player, etc. As will be explained more below, the gateway module 46 may act as a receiving device for OTA or instructional updates from the backend system 16—e.g., these updates may be provided to the gateway module from time-to-time and consequently, the gateway module 46 may be configured to provide them to the respective VSMs 32 within the vehicle 24, as appropriate.

The illustrated gateway module 46 includes a processor 62, memory 64, and an auxiliary or back-up power supply or power source 66. Processor 62 may be any type of device capable of processing and/or executing instructions, including microprocessors, microcontrollers, host processors, controllers, vehicle communication processors, and application specific integrated circuits (ASICs). It may be a dedicated processor (used only for module 46), or it can be shared with other vehicle systems. For example, in at least one embodiment, the processor 62 may perform or execute a number of instructions stored on memory 64, including one or more of the following: (1) receiving electrical inputs or parameters D, E, F, G, H from various vehicle system modules, circuits, sensors, switches, etc. (including receiving electrical parameters from BCM 44, as shown) (e.g., which may be indicia that the vehicle is in the stationary state); (2) assessing or determining whether the vehicle 24 appears to be in the stationary state based on the received electrical parameters, wherein this assessment has a certain confidence level; and (3) in response to receiving the parameters and making the assessment that the vehicle 24 appears to be in the stationary state (wherein this assessment meets or exceeds a predetermined threshold confidence level), then providing a second trigger or other suitable signal as an output (e.g., see T2). Thus, the processor 62 may carry out at least a portion of the method described herein, as will be discussed in greater detail below.

In FIG. 2, parameter D is received at module 46 from the mechanical parking brake sensor P (which may be routed through the BCM 44), and parameter E may be received from an electronic parking brake sensor (e.g., associated with a electronic braking system (not shown). Parameter F may be associated with a measured vehicle speed and may be received from (or determined by data from one or more of) the ECM, an antilock braking system (ABS) system (not shown) or the like. Parameter G may be associated with whether the vehicle transmission is in PARK and may be received from a vehicle gear selection sensor (e.g., from a powertrain module (not shown)); e.g., parameter G may indicate PRNDL position (i.e., one of park, reverse, neutral, drive, low, etc.). And parameter H may be received from the vehicle ignition system 36 (and in at least one instance parameter H may be equal to or the same as parameter B, which was discussed above). Parameters D-H are illustrative and other parameters could be transmitted to and received by the gateway module 46 in other embodiments.

Memory 64 of gateway module 46 may be coupled to the processor 62 and may be used to store parameter data (e.g., D-H data) and other data associated with the operation of the gateway module. Memory 64 includes any non-transitory computer usable or readable medium, which includes one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one implementation, the memory 64 includes non-volatile memory (e.g., ROM, EPROM, EEPROM, etc.). These of course are merely examples; other implementations are contemplated herein.

Auxiliary power source 66 of gateway module 46 includes any suitable power storing device coupled to a circuit that includes the processor 62 and memory 64. The power supply 66 can be adapted to provide sufficient power to carry out at least a portion of the method described herein when the vehicle ignition system 36 is powered OFF. Non-limiting examples include a battery (e.g., a rechargeable battery), one or more capacitive devices, and the like. In other implementations, the power source 66 is not contained within the gateway module 46; e.g., the power source 66 may represent a portion of a vehicle power budget—e.g., a percentage of Amp-hours allotted to the gateway module 46 from the primary vehicle battery (not shown).

Turning now to VSM 48, target VSM may be any VSM (32) located in the vehicle 24 for which a software update is available. For example, the target VSM 48 may be identified by the gateway module 46, e.g., when the gateway module 46 receives a notification or an update from the backend system 16 that is directed to the particular VSM. Thus, the VSM 48 may be the ECM, the PCM, a brake control module, a transmission control module, or any one of a number of other VSMs not listed here. In one embodiment, the target VSM 48 could be the body control module 44 or the gateway module 46 as well. Thus, target module 48 can represent any system module or ECU coupled to the network connection 34.

The illustrated VSM 48 includes an electronic control unit (ECU) 70 that controls a number of operations and functions of the respective VSM, and the ECU 70 comprises a processor 72 and memory 74. Processor 72 can be any type of device capable of processing and/or executing instructions, including microprocessors, microcontrollers, host processors, controllers, vehicle communication processors, and application specific integrated circuits (ASICs). It could be a dedicated processor (used only for module 48), or it could be shared with other vehicle systems. Further, memory 74 includes any non-transitory computer usable or readable medium, which includes one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one implementation, the memory 74 includes non-volatile memory (e.g., ROM, EPROM, EEPROM, etc.). These of course are merely examples; other implementations are contemplated herein.

As will be described more below, the processor 72 may perform or execute a number of instructions stored on memory 74. For example, processor 72 may be configured to perform one or more of the following: (1) receive one or more trigger or enable signals (e.g., such as the first and second trigger signals T1, T2 described above) (e.g., these trigger signals may be considered parameters or indicia to the processor 72 that the vehicle 24 is in the stationary state); (2) in response to receiving the first and second trigger signals, determine whether the vehicle 24 is in the stationary state, wherein the determination has a certain confidence level; (3) when it is determined that the vehicle 24 is in the stationary state and the determination meets or exceeds a predetermined threshold confidence level (e.g., that is higher the confidence levels associated with the first and second triggers), then authorize the installation of a software update at the ECU 70; (4) receive the software update from the gateway module 46 (or other system module 32) in response to the authorization; and (5) reflash the memory 74 using the software update in response to the authorization and in response to receiving the software update (e.g., perform a reflashing procedure). These instructions of course are merely examples; in a preferred embodiment, the processor 72 executes other instructions stored on memory 74 as well (e.g., such as instructions associated with the particular vehicle function and/or operations carried out by the particular VSM 48).

As will be appreciated by skilled artisans, reflashing a device or performing a reflashing procedure is a process that applies a software update to a targeted memory device so that the associated processor can carry out new, different, or modified instructions. Thus, as used herein, reflashing a device includes adding, overwriting, modifying, appending, pre-pending, and/or deleting instructions stored within a non-transitory computer readable medium (e.g., within memory 74). Thus, the reflashed device may include entirely new instructions, some new instructions and some instructions which existed prior to the reflash procedure, etc.

As shown in FIGS. 1-2, the network connections 34 between VSMs 32 (and the particular VSMs 44-48) include any wired intra-vehicle communications system for connecting or coupling the VSMs and other vehicle electronic devices to one another. According to one embodiment, the network connection 34 comprises a data bus (e.g., a communication bus, entertainment bus, etc.). Non-limiting examples of suitable network connections include a controller area network (CAN), a media oriented system transfer (MOST), a local interconnection network (LIN), a local area network (LAN), and other appropriate connections such as Ethernet, Audio-Visual Bridging (AVB), or others that conform with known ISO, SAE and IEEE standards and specifications, to name but a few. It should be appreciated that other implementations include discrete wired or wireless connections, which may be used instead of or in combination with the data bus(es) described above.

FIG. 2 also illustrates the vehicle ignition system 36 which may include any suitable electrical system which aids in powering the vehicle engine (not shown). For example, in combustion engine systems, the system 36 may distribute electricity to provide the sparks necessary to ignite fuel within the engine. Or for example, in fully-electric vehicles, the system 36 may trigger the operation of electric motors which propel the vehicle 24. Regardless, the ignition system 36 may include any suitable switch, key, or sensor actuation—e.g., detecting actuation of a power ON button by a driver, detecting actuation of a vehicle key in an ignition switch, receiving and detecting a cellular or SRWC wireless signal indicating an authorized vehicle user desires to start the engine, etc. The ignition system 36 may be powered ON (e.g., to an ON state or mode) and powered OFF (e.g., to an OFF state or mode), and as described more below, the state of the ignition system may be one indication of whether the vehicle 24 is stationary (e.g., it will be appreciated that a vehicle still may move even when the ignition system is OFF). When the ignition system is ON, the system 36 may provide an output—e.g., parameters B and H (e.g., indicating system is ON). Similarly, when the system is OFF, system 36 may provide parameter data B and H indicating the system is OFF. Other ignition system states may also exist; these are merely two non-limiting examples.

Below, one or more methods of using the communications system 10 will be described. More particularly, at least one embodiment of a method of using the software update system 30 in the vehicle 24 will be described.

### Method

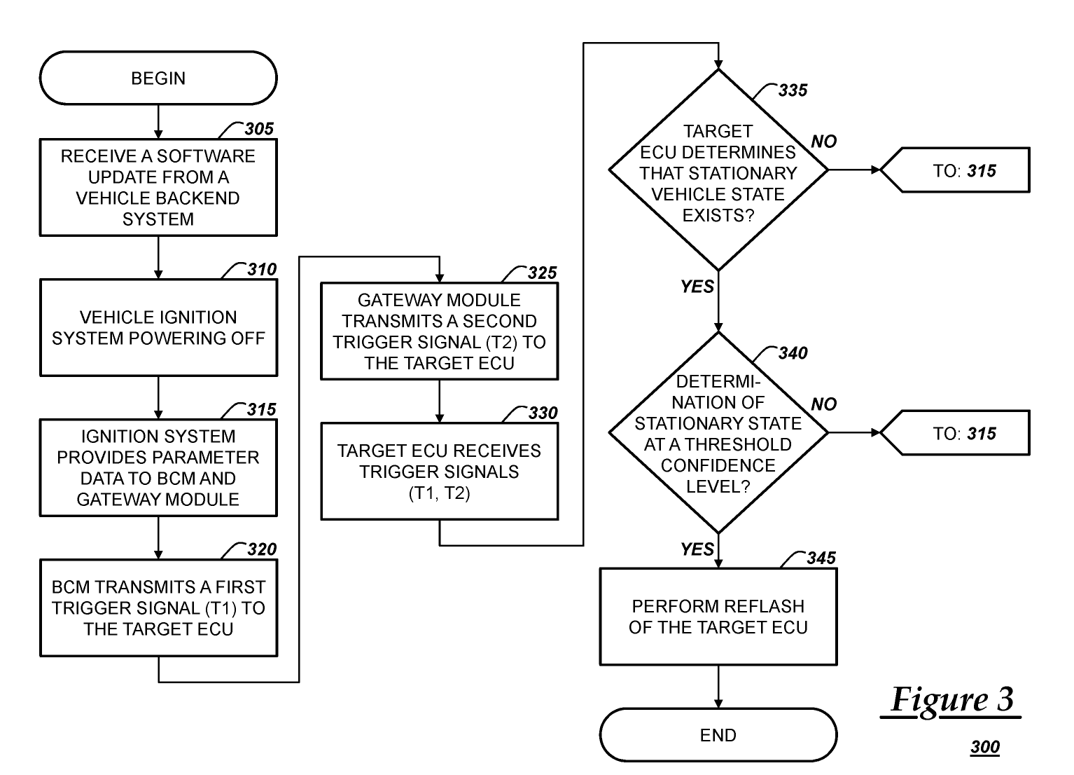

As shown in the flow diagram of FIG. 3, a method 300 is illustrated that pertains to determining whether to install a software update at ECU 70 in the target VSM 48. The method may begin while the vehicle is in the non-stationary state. For example, a vehicle user may be driving the vehicle 24 and the gateway module 46 may receive a notification of a vehicle system or software update (step 305) via an over-the-air communication or in any other suitable manner. In at least some instances, the notification may be simply receiving the update.

Step 305 may include other steps as well. For example, in step 305, the gateway module 46 may send a message to the target VSM 48 (e.g., or more particularly to the target ECU 70); the message may notify the ECU 70 that a software update is available requiring a reflash procedure. In response to receiving this message, the ECU 70, in some instances, may be configured to stay awake or active when the vehicle ignition system 36 powers down. In other implementations, the ECU 70 may be woken up (e.g., by the gateway module 46) after the vehicle ignition system 36 has powered down.

In step 310 which follows step 305, the vehicle ignition system 36 may power OFF. This may occur in any suitable manner, as described above—e.g., after detecting actuation of a power OFF button by a vehicle user, detecting de-actuation of a vehicle key in an ignition switch, receiving and detecting a cellular or SRWC wireless signal indicating an authorized vehicle user desires to stop the engine, etc., just to cite a few examples.

In step 315, vehicle ignition system 36 may transmit parameter data (e.g., B, H) indicating that the ignition system 36 is about to power OFF or that it has powered OFF—e.g., parameter B may be sent to the BCM 44, and parameter H may be sent to the gateway module 46. Steps 310 and 315 may occur in any suitable order or at least partially concurrently. In one embodiment, step 315 occurs just before the ignition system 36 has powered down—e.g., the ignition system 36 sends a message over the bus 34 that a power down sequence is in process. According to this embodiment, the auxiliary power source 66 of the gateway module 46 may be triggered to be operative in lieu of vehicle battery power.

In another embodiment of step 315, the parameter data B, H behaves as a low-voltage enable signal. For example, when the ignition system 36 is powered ON, the parameter data B, H may be a high or 5V signal (e.g., a digital ‘1’) and when the ignition system 36 is powered OFF, the parameter data B, H may be low or drop to a 0V signal (e.g., a digital ‘0’). These embodiments are merely examples; other implementations are also possible.

Steps 320 and 325 follow; these steps may occur in any suitable order or at least partially concurrently. In at least one embodiment, step 325 occurs in response to step 320. For example, in step 320, the BCM 44 provides a trigger signal T1 to the processor 72 of ECU 70 based on assessing or determining that the vehicle 24 appears to be in the stationary state. This assessment may be based on receiving and analyzing a set of parameters or indicia (A, B, C, . . . ), and the assessment may be associated with a certain confidence level. For example, BCM 44 may receive parameter data A from the mechanical parking brake sensor P (e.g., a mechanical brake may or may not be applied). Parameter data B may be received the vehicle ignition system 36 and may or may not indicate that the system 36 is powered OFF (per step 315). And parameter data C may be received from one or more electrical circuits, sensors, modules, etc. in the vehicle 24 and may provide any other suitable indication that the vehicle might be in the stationary state (e.g., electronic brake sensor data (e.g., applied or not), seat sensor data (e.g., driver present or not), door sensor data (e.g., door opened and closed recently or not), etc.). Thus, when the assessment by the processor 52 is that the vehicle 24 appears to be in the stationary state and when the confidence level meets or exceeds a predetermined threshold confidence level, then BCM 44 transmits the trigger signal T1.

It should be appreciated that the term ‘set’ (e.g., ‘set of parameters’) as used herein, includes one or more elements (e.g., parameters, inputs, indicia, etc.). Further, the system module (e.g., the BCM 44) need not evaluate or analyze each or every parameter in a given set. For example, the BCM 44 may receive three parameters (A, B, C); however, in making its assessment, the BCM may analyze a set of only one (e.g., parameter B), a set of only two (e.g., parameters A and B), etc.

In at least one embodiment, the trigger signal T1 indicates a vehicle power mode of the vehicle ignition system 36, which was assessed by the BCM 44. For example, the vehicle ignition system 36 may have two or more states or modes, as discussed above. Regardless, in at least one implementation, the trigger signal T1 indicates at least one of an ignition system power OFF mode or an ignition system power ON mode.

Furthermore, in at least one embodiment, step 320 includes transmitting the trigger signal T1 to the gateway module 46, as well as ECU 70. For example, FIG. 2 illustrates that the signal T1 may actuate or trigger the auxiliary power source 66. Thus, when the processor 52 determines that the vehicle ignition system 36 is powering down, the power source 66 may power ON so that the gateway module 46 may be active when other vehicle electronics are asleep or unpowered. While not illustrated in FIG. 2, some embodiments of the BCM 44 may include an auxiliary power source as well—which may be triggered by signal T1 as well.

As discussed above, each assessment may have an associated confidence level. According to one embodiment, confidence levels may utilize probabilities, other statistical data, or the like. The associated confidence level may take into account that the reliability of the assessment made by processor 52 may only be as good as the reliability and/or accuracy of the received electrical parameters (e.g., A, B, C, etc.). For example, it is contemplated that in at least some instances, the parameters A-C received by processor 52 could include inadvertent errors or be altered maliciously (e.g., by a hacker who has gained access to the software update system 30). Thus, processor 52 has the capability to assess a probability that the assessment is accurate.

Probabilities are merely an example; other implementations also exist. For example, in at least one embodiment, the confidence level is based upon an industry standard such as an Automotive Safety Integrity Level (or ASIL), as defined in ISO 26262-1 (published Nov. 15, 2011), the entirety of which is hereby incorporated by reference. Thus, in this embodiment, when the processor 52 assesses that the vehicle 24 appears to be in the stationary state, the processor may base this assessment on an ASIL value. It will be appreciated that ASIL values can account for a number of criteria (e.g., probabilities plus more). Thus, for example, processor 52 may provide trigger signal T1 according to an ASIL-B confidence level. It should be appreciated that this is merely one example (e.g., the trigger signal could be according to an ASIL-A or ASIL-C confidence level instead—e.g., in other embodiments). Further, it should be appreciated that the ASIL value may be determined by the processor 52, or the parameters provided to the BCM 44 may define the ASIL value. Further, it should be appreciated that some vehicle modules (e.g., such as the BCM 44, gateway module 46, etc.) may be so-called ASIL-B modules; similarly, the electronic control units (ECUs) therein (e.g., including processor 52, processor 62, etc.) could be so-called ASIL-B ECUs.

In step 325 (FIG. 3), the gateway module 46 provides a trigger signal T2 to processor 72 of ECU 70 based on an assessment that the vehicle appears to be in the stationary state, wherein this assessment meets or exceeds a predetermined threshold confidence level. This assessment is based on receiving and analyzing a set of parameters or indicia (D, E, F, G, H, . . . ), and the assessment is associated with a certain confidence level. For example, gateway module 46 may receive parameter data D from the mechanical parking brake sensor P (e.g., mechanical brake applied or mechanical brake not applied). Parameter E may be received from an electronic parking brake sensor (e.g., applied or not). Parameter F may be received from a speed sensing VSM or system such as the ECM or ABS system (e.g., the parameter may indicate vehicle speed of 0 mph or more than 0 mph). Parameter G may be received from a vehicle gear selection sensor (e.g., indicating one of Park, Reverse, Neutral, Drive, Low, etc.). And parameter data H may be received from the vehicle ignition system 36 and may or may not indicate that the system 36 is powered OFF (per step 315). Of course, other parameters not shown may provide other additional parameter data (e.g., including but not limited to electronic brake sensor data (e.g., applied or not), seat sensor data (e.g., driver present or not), door sensor data (e.g., door opened and closed recently or not), etc.). Regardless of the quantity of received parameters, when the assessment by the processor 62 is that the vehicle 24 appears to be in the stationary state and when the confidence level meets or exceeds a predetermined threshold confidence level, then gateway module 46 transmits the trigger signal T2.

Similar to the step 320, step 325 may determine a confidence level using probabilities, ISO 26262, or the like. And in at least one embodiment, the processor 62 provides trigger signal T2 according to an ASIL-B confidence level. This is merely one example however; other ASIL implementations (and other confidence level implementations) are also possible. Further, it should be appreciated that the ASIL value may be determined by the processor 62, or the parameters provided to the gateway module 46 may define the ASIL value.

In step 330, the trigger signals T1 and T2 are received by the processor 72 (in the target ECU 70). For example, as shown in FIG. 2, the first trigger signal T1 may be sent from the processor 52 to the gateway module 46 (e.g., to the auxiliary power source 66) and also to the target ECU 70 (e.g., to processor 72). And the second trigger signal T2 may be sent from the processor 62 to the target ECU 70 (e.g., to processor 72). Each of the first and second trigger signals T1, T2 may include data indicative of a confidence level as well, as discussed below. Alternatively, upon receipt of the first and second trigger signals T1, T2, the ECU 70 may associate a predefined or predetermined confidence level. This too is discussed below.

Steps 335 and 340 follow step 330. In step 335, the target ECU 70 determines whether the vehicle 24 is in the stationary state based on receiving the trigger signals T1, T2, wherein this determination has a certain confidence level as well (which is assessed in step 340 below). For example, in one embodiment of step 335, when the processor 72 receives trigger signals T1 and T2 at least partially concurrently, the processor 72 determines that the vehicle is in the stationary state. For example, merely receiving both triggers signals T1, T2 concurrently may be sufficient to determine the stationary state. When this occurs, the method 300 proceeds to step 340, and when this does not occur, the processor 72 may determine that the non-stationary state exists—and consequently may loop back or return to step 315 (e.g., and wait for the next time the vehicle ignition system 36 provides parameter data to the BCM 44 and the gateway module 46). Of course, this is merely one example, and in other embodiments, the method could loop back to a different step instead.

In other embodiments of step 335, the target ECU 70 may evaluate additional trigger or enable signals from other system modules, vehicle sensors, etc. For example, three or more signals may be required to determine the stationary state.

In step 340, the target ECU 70 determines whether the determination in step 335 meets or exceeds a predetermined confidence threshold level. For example, trigger signals T1, T2 may include data indicating their respective confidence levels. For example, probability data may be included with the trigger signals and processor 72 may determine a confidence level based on the data received from the BCM 44 and gateway module 46. If the calculated confidence level meets or exceeds the threshold confidence level of the ECU 70, then the method 300 may proceed to step 345; if it does not, then the method may loop back to step 315 (or any other suitable step).

In another implementation of step 340, the processor 72 may evaluate two ASIL values. For example, the processor 72 may determine that an ASIL-B value (of trigger signal T1) and an ASIL-B value (of trigger signal T2) may correlate to an ASIL-D value—which, as will be appreciated by skilled artisans, is the highest ASIL value (e.g., a highest threshold ASIL value). Skilled artisans will appreciate that ASIL values (A, B, C, and D) correspond with both qualitative and quantitative metrics. For example, qualitatively, an ASIL-D includes high coverage with respect to “single point fault requirement,” high coverage with respect to “plausible dual point fault/latent fault requirements,” and requires dependent failure evaluation. And as appreciated by skilled artisans for example, quantitatively, an ASIL-D value corresponds to a “failure rate/operation hour” of less than 10⁻⁸ occurrences. Thus, in at least one embodiment, the processor 72 may have the highest confidence level that the vehicle 24 is in the stationary state prior to reflashing the ECU 70. This of course is merely one example; other embodiments exist. For example, the processor 72 may receive two or more trigger or enable signals—each having ASIL values of ASIL-A, ASIL-B, or ASIL-C—and correlate these combined ASIL values to an ASIL-D value.

In step 345, the memory 74 of ECU 70 is reflashed using the software update. For example, the gateway module 46 may store the update in memory 64 during steps 305-340 and, as part of step 345, the gateway module 46 may provide the update to the ECU 70. In at least one embodiment, the ECU 70 may refuse to receive (e.g., ignore) any software updates transmitted to it without the ECU 70 first completing steps 335 and 340. For example, in this manner, the ECU 70 may inhibit a reflash event in instances when a hardware or software error has occurred or when a malicious entity has infiltrated the vehicle network or bus 34.

According to one embodiment of step 345, the gateway module 46 performs the reflash of ECU 70, and according to another embodiment, the ECU 70 reflashes itself upon receipt of the software update (e.g., when method 300 proceeds from step 340 to 345). Reflashing may or may not include rebooting (e.g., powering down and then powering up again the ECU 70). Other aspects of reflashing memory 74 will not be discussed herein, as reflashing memory is generally known in the art.

In general, it should be appreciated that the ECU 70 determines whether to reflash using the software update. In this manner, network security is improved as each respective VSM ECU has the opportunity to determine—based on trigger signals whether the vehicle is in the stationary state prior to reflash, and each VSM ECU has the opportunity to calculate or determine a confidence level—based on the confidence levels of the associated trigger signals.

Following step 345, the method may end. It should be appreciated that the method 300 may repeated for other VSMs 32. In some instances, method 300 may be performed with respect to two or more target VSMs concurrently.

Other embodiments also exist. For example, the BCM 44 may transmit the first trigger signal T1 to the target ECU 70 (e.g., over the bus 34) prior to the vehicle ignition being OFF, and the gateway module 46 may transmit the second trigger signal T2 to the target ECU 70 (e.g., over bus 34) after the vehicle ignition is OFF. Further, the ECU 70 may be configured to store and execute additional instructions which include: storing data associated with the first trigger signal at the target ECU, and using that data to determine whether the vehicle is in the stationary state until an updated trigger signal T1 is received from the BCM 44. For example, receipt of the trigger signal T1 may serve a latching function—e.g., so that the ECU 70 may repeatedly evaluate only the trigger signal T2 of the gateway module 46 (e.g., waiting for gateway module 46 to assess that the vehicle 24 appears to be in the stationary state with some level of confidence).

In another example, the method above describes receiving OTA updates. However, in at least one embodiment, the update could be performed at a vehicle service center or other location. For example, the update system 30 could be used as an additional safeguard against service technician error—e.g., a safeguard against not placing the vehicle 24 entirely in the stationary state prior to update installation attempts.

Thus, there has been described a method of determining whether to install a software update in a vehicle. More particularly, there has been described a method that determines whether the vehicle is a stationary state and that also inhibits the installation of the software update until the vehicle is in the stationary state according to a predetermined level of confidence.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of determining whether to install a software update at an electronic control unit (ECU) in a vehicle, comprising the steps of:
receiving at the ECU a first signal from a first vehicle system module (VSM) in the vehicle;
receiving at the ECU a second signal from a second VSM in the vehicle, wherein the first and second signals each provide an indication that the vehicle is in a stationary state;
based on the first and second signals, assessing at the ECU that the vehicle is in the stationary state, wherein the assessment is in accordance with a first predetermined confidence level; and
in response to the assessment, authorizing at the ECU an installation of the software update on ECU memory.

2. The method of claim 1, wherein each of the first and second signals are associated with predetermined confidence levels that are lower than the first predetermined confidence level.

3. The method of claim 1, wherein at least one of the first or second signals is associated with an Automotive Safety Integrity Level B (ASIL-B), wherein the first predetermined confidence level is associated with ASIL-D, wherein ASIL-B and ASIL-D are associated with ISO-26262.

4. The method of claim 1, wherein the ECU receives the first signal in response to the first VSM assessing a vehicle power mode based at least in part on communication between the first VSM and a vehicle ignition system.

5. The method of claim 1, wherein the ECU receives the second signal in response to the second VSM assessing that the vehicle is in the stationary state using one or more of the following parameters: an input from a vehicle mechanical parking brake sensor, an input from an electronic brake sensor, an input associated with vehicle speed, or an input associated with a vehicle gear selection.

6. The method of claim 1, wherein at least one of the receiving steps, the assessing step, or the authorizing step occurs when a vehicle ignition system is powered OFF.

7. The method of claim 1, wherein the assessing step further comprises:
assessing at the ECU that the first signal is associated with a second predetermined confidence level;
assessing at the ECU that the second signal is associated with a third predetermined confidence level, wherein the second and third confidence levels are lower than the first confidence level; and
determining the first confidence level at the ECU based on receiving the first signal having the second confidence level and the second signal having the third confidence level.

8. A software update system for a vehicle, comprising:
a vehicle system module (VSM) configured to determine a first assessment of whether the vehicle is in a stationary state using a first set of parameters;
a gateway module configured to determine a second assessment of whether the vehicle is in the stationary state using a second set of parameters, wherein at least some of the parameters of the second set differ from the parameters of the first set; and
a target electronic control unit (ECU) having a processor coupled to memory, wherein the memory stores a plurality of instructions executable by the processor, including:
instructions to receive data associated with the first and second assessments from the VSM and the gateway module, respectively;
instructions to assess whether the vehicle is in the stationary state in response to receiving the first assessment data and the second assessment data; and
instructions to authorize an installation of a software update when the processor determines that the vehicle is in the stationary state.

9. The system of claim 8, wherein the instructions to assess that the vehicle is in the stationary state include instructions to determine a first predetermined confidence level associated with the assessment that the vehicle is in the stationary state.

10. The system of claim 9, wherein the VSM is configured to transmit a first signal associated with the first assessment to the target ECU, wherein the gateway module is configured to transmit a second signal associated with the second assessment to the target ECU, wherein the first and second signals are associated with predetermined confidence levels that are lower than the first predetermined confidence level.

11. The system of claim 10, wherein at least one of the first or second signals is associated with an Automotive Safety Integrity Level B (ASIL-B), wherein the first predetermined confidence level is associated with ASIL-D, wherein both ASIL-B and ASIL-D are associated with ISO-26262.

12. The system of claim 8, wherein the VSM is configured to determine a vehicle power mode based at least in part on communication between the VSM and a vehicle ignition system.

13. The system of claim 8, wherein the first set of parameters includes: an input from a vehicle mechanical parking brake sensor and an input from a vehicle ignition system, wherein the first assessment is based on at least one of the first set of parameters.

14. The system of claim 8, wherein the second set of parameters includes: an input from a vehicle mechanical parking brake sensor, an input from an electronic brake sensor, an input associated with vehicle speed, and an input associated with a vehicle gear selection, wherein the second assessment is based on at least one of the second set of parameters.

15. The system of claim 8, wherein the VSM is configured to transmit a first trigger signal associated with the first assessment to the gateway module and to the target ECU, wherein the gateway module is configured to transmit a second trigger signal associated with the second assessment to the target ECU, wherein, when the gateway module receives the first trigger signal, the gateway module is configured to actuate a back-up power supply in the gateway module so that the gateway module may perform the second assessment when the vehicle ignition is OFF.

16. The system of claim 15, wherein the VSM is configured to transmit the first trigger signal to the target ECU over a vehicle communication bus prior to the vehicle ignition being OFF, wherein the gateway module is configured to transmit the second trigger signal to the target ECU over the bus after the vehicle ignition is OFF, wherein the plurality of stored instructions further comprises: instructions to store data associated with the first trigger signal at the target ECU, and instructions to use that data to assess whether the vehicle is in the stationary state until a different trigger signal is received from the VSM.

17. The system of claim 8, wherein the plurality of stored instructions further comprise:
instructions to receive the software update from the gateway module in response to the authorization; and
instructions to reflash the memory of the target ECU with the software update in response to receiving the stationary update.

18. The system of claim 8, wherein the gateway module is adapted to communicate with a vehicle backend system and receive one or more stationary updates for a plurality of ECUs in the vehicle.

19. A computer program product, comprising a non-transitory computer readable medium for an electronic control unit (ECU) in a vehicle, comprising computer program instructions that enable a processor of the ECU to install a software update in memory of the ECU when the vehicle is in a stationary state, said computer program instructions comprising:
instructions to receive a first signal from a vehicle system module (VSM) in the vehicle, wherein the first signal is associated with an assessment by the VSM that the vehicle is in the stationary state;
instructions to receive a second signal from a gateway module in the vehicle, wherein the second signal is associated with an assessment by the gateway module that the vehicle is in the stationary state;
instructions to determine whether the vehicle is in the stationary state in response to receiving the first and second signals, wherein the determination is in accordance with a predetermined confidence level;
instructions to authorize an installation of the software update when the processor determines that the vehicle is in the stationary state;
based on the authorization, instructions to receive the software update from one of a plurality of VSMs in the vehicle; and
based on receiving the instructional update, instructions to reflash the memory device with the software update.
